(19) United States
(12) Patent Application Publication
(10) Pub. No.: US 2012/0047428 A1
(43) Pub. Date: Feb. 23, 2012

(54) Method for Creating Browsable Document for a Client Device

(75) Inventors: Katja Nykänen, London (GB); Ferene Dosa-Racz, Espoo (FI)

(73) Assignee: Nokia Corporation, Espoo (FI)

(21) Appl. No.: 11/988,618

(22) PCT Filed: Jul. 13, 2005
(86) PCT No.: PCT/FI2005/050280

§ 371 Date: Jan. 11, 2008

(51) Int. Cl. G06F 17/00; G06F 15/16

(52) U.S. Cl. 715/235

(57) ABSTRACT

This invention relates mobile servers and client devices (150) and the data that is transferred between them and that is browsable in the client device (100). In particular, this invention relates to a method for creating browsable document with personalized and/or context dependent look for the client device (100). In the method for creating a browsable document to be presented on a display, wherein a content for said document is retrieved upon request, context data relating to a personal device is determined. An information on a style relating to said context data is defined and the browsable document is parsed by means of the content and the information on the style.

### CROSS-REFERENCE TO RELATED APPLICATION

This application is the U.S. National Stage of International Application Number PCT/FI2005/0502080 filed Jul. 13, 2005 and published in English Jan. 18, 2007 under International Publication Number WO 2007/006839 A1.

### FIELD OF THE INVENTION

This invention relates mobile servers and client devices and the data that is transferred between them and that is browsable in the client device. In particular, this invention relates to a method for creating browsable document with personalized and/or context dependent look for the client device.

### BACKGROUND OF THE INVENTION

Electronic documents in computer systems can be viewed by using a browser (in a client device), which retrieves a document from a server and presents it on a display. Currently electronic documents to be browsed are so called web pages that are created on purpose to web browsers. The web page is often designed by using known markup languages and the page is often associated with graphics, links and other creative styles. The web applications and web services can generate many kinds of content upon request from a client device.

Traditionally web page content, i.e. electronic document is stored in a server that is located in a computer system that is rather stationary and may have a fixed connection to network. The server serves the document with markup language to a client device's browser, which is capable of understanding the markup language and displaying the document correctly on a display of the client device. The content to be shown may not necessarily be plain text, but it can also provide interaction elements, such as buttons and hyperlinks. The basic thing on a web technology is to provide data to be shared with plurality of client devices publicly or privately. The client device requesting the content can be a fixed or wireless computer system, but also a mobile device. In local networks, such as company's network, the stationary server is usually shared with employees. Therefore data, e.g. calendar, is served to authenticated users in client devices that are connected to the server, and such a users may edit the served data.

As said, traditional server are stationary, but publication US 2003/0076792 A1 also introduces a possibility of a mobile device to be a server. Such server is in this description referred as mobile server. The different aspects of mobile server being a web server is already known. However, it can be seen that the mobile server will create further needs for both owners of the mobile servers and the users of client devices. Therefore this invention is not based on existing problem, but relates to the aforementioned needs.

### SUMMARY OF THE INVENTION

The current invention is addressed to expected internet usage and possibilities in a situation where a personal device, such as mobile terminal, operates as a host for a webserver. It is known that methods for customizing the look of a personal device by covers or by designed user interfaces are currently used for personalization. This invention expands the personalization by giving an opportunity to share a personal look also in client devices. In other words the current invention is about defining skins for mobile web applications based on different kinds of data, e.g. configurational or contextual data in the personal device.

The current invention provides a method for enabling the personalization of mobile homepages, but also personalization of other mobile content that can be shared via web interface. In addition the current invention aims to provide a customized look for the content of the personal device, whereby the feature and the usability will be maintained.

Therefore it is an object of this invention to provide a method for creating a browsable document, which method comprises steps for determining context data relating to a personal device, for defining an information on a style relating to said context data, for parsing the browsable document by means of the content and the information on the style.

Another object of the current invention is to provide a configuration database comprising means for determining context data relating to a device and for defining an information on a style relating to said context data

Another object of the current invention is to provide a device being capable of determining context data relating to said device, of defining an information on a style relating to said context data and of transferring the browsable document with the content and the information on the style to the client device.

Another object of the current invention is to provide a computer program product comprising code means stored on a readable medium, adapted, when run on a computer, to determine context data relating to a personal device, to define an information on a style relating to said context data, to parse the browsable document by means of the content and the information on the style.

The invention is to serve and possibly to generate configuration style (e.g. CSS, Cascading Style Sheet) on the mobile server based on different kind of context data that is available to the server at the time of serving the request. The personal device may provide rules to control what kind of context data is used in which situation. By using the configuration style, it is possible to copy the look and feel of the personal device's user interface to the web site that is provided to client device. The context awareness further brings wider aspects to the current invention.

The present invention has far-reaching advantages for the mobile technology. First of all, personalization of the browsable content relating to phone applications becomes easy by automatization of the technical details, which obviously facilitates the content owner's efforts for sharing data, or even designing and writing document's layout. The one of the most important gains of this invention is that “skin” (i.e. appearance) is possible to such web application to which the owner provides only the data and context (contacts, messages, logs, default “homepage” application with blog etc. combined), but not the application itself. While it is possible for an owner to write proprietary pages, even homepage that uses such style infrastructure only a very few percentage would have the knowhow, and even less the time and interest to actually do it so. Therefore personal devices' owners can configure their own dynamic styles to be used on the web page and stored on the personal device server. The styles can also be stored on a server external to the personal devices, whereby the owner is enabled to use newer style versions and improvements.

Basically, due to this invention, the personal information in the personal device is possible to be provided to other computing devices. The present invention more effectively tightens the relationship of these two computer systems, because the content of a personal device can be shared with the other computer with a similar look, which also improves usability of the content.

### DESCRIPTION OF THE DRAWINGS

The present invention is described by means of examples provided by the accompanying drawings and the description that follows. The examples are provided for understanding purposes only and therefore unnecessary limitations should not be drawn from them.

FIG. 1 illustrates an example of a system according to the invention,

FIG. 2 illustrates another example of a system according to the invention,

FIG. 3 illustrates an example of signalling in relation to FIG. 1,

FIG. 4 illustrates an example of signalling in relation to FIG. 2,

FIG. 5 illustrates an example screenshots, wherein the client device and the personal device have same theme,

FIG. 6 illustrates an example screenshots, wherein themes are differentiated in client device depending on the logging,

FIG. 7 illustrates an example screenshots, wherein calendars are compared, and

FIG. 8 illustrates an example of a personal device according to the invention.

### DETAILED DESCRIPTION OF THE INVENTION

In this invention web browsable content is provided from a personal device to a client device. The personal device here refers to a mobile device, such as a mobile phone, a smart phone, a communicator, a PDA device. Client device can be also mobile device or a wired or wireless personal computer. In client device a browser is in important role. The browser is capable of creating the content from the mobile server and of displaying it correctly on the display. Web browsable content relates naturally to web pages hosted by mobile server, e.g. home page, but this invention makes it possible also to have an access to personal device applications, such as e.g. calendar, contacts, messages, logs via the web interface. In addition, a mobile web server (“mobile server”) may act as a host of mobile/weblogs and galleries. The web browsable content may be formed by using known markup languages, such as e.g. HTLM or XHTML. During the process of the invention the content is provided with style configuration, which style configuration may be formed by the known Cascading Style Sheets (CSS). CSS is a language that is used for describing the presentation of the electronic document that is written in the markup language. CSS is used to define e.g. colours, fonts, layout and other style features for the document presentation. Term “context data” in this description refers to e.g. to a settings in a personal device or to other data that is used for determining which configuration style is to be used for the requested content. The “configuration data” refers to a layout settings and to a style data that determines how the browsable content should look like. The idea of this invention is to generate requested content to look similar to the content in the personal device. This means that the user interface features of the personal device are brought according to setting of the personal device at a certain point, to the content in the browser.

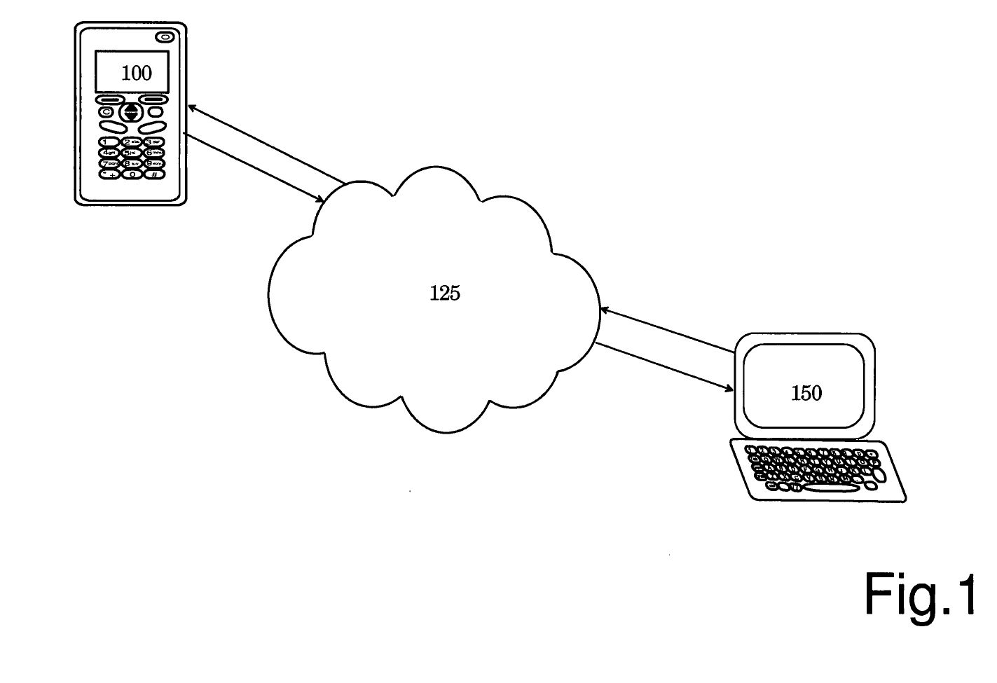

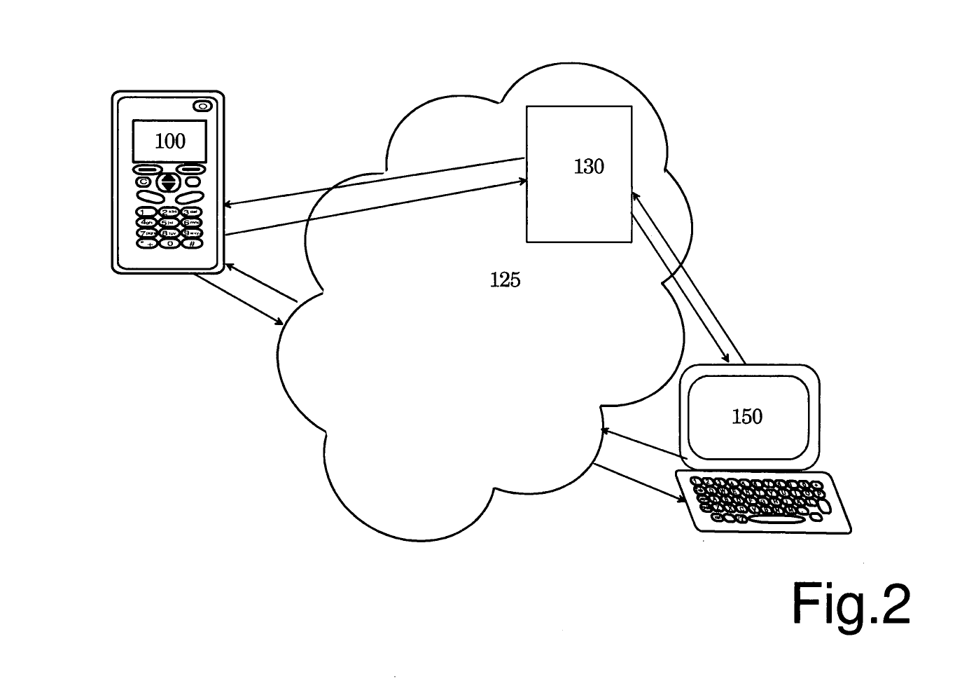

One example of a system according to the invention is illustrated in FIG. 1 in a simplified manner. In this example personal device, such as a mobile terminal 100 comprises a mobile server. When a client device 150 requests a web page or other content data from the mobile terminal 100, the mobile server provides the requested data to the client device 150 with a customized style via network 125. The customised style is determined according to the settings in the mobile terminal 100. In FIG. 2 another example is illustrated. The difference to the FIG. 1 is the external server 130 for providing the style for the content of the personal device. Therefore after receiving a request from the client device 150, the mobile terminal 100 determines its settings and requests a corresponding style from the external server 130. Two examples are described of how a style document is got to the client device. First example is to embed the style configuration into the returned browsable document, wherein in one go the browser gets both the content and the style in the same document. This means that style configuration originates from the device 100, and also that there are no additional roundtrips to retrieve the style document. This example relates to FIG. 1. In another example a style configuration can be externally linked to the browsable document that refers to it. In this example there may be a need to extra roundtrip for the browser to get the style configuration the page prescribes itself to be rendered with. Now, this external style configuration (“external” from the browsable document's point of view) may still come from the device 100 (see FIG. 1), or it can come from another server 130 (see FIG. 2).

The system may comprise also a configuration database being stored e.g. on the personal device 100. The configuration database is arranged to define rules about what kind of context data is to be taken into account and to what result. The context data in case of mobile server can be for example:
URL page being requested (e.g. main page, web applications with private data, moblog, family pictures) as part of the request
the user agent, e.g. an identifier of the browser software as part of the request
the identity of the internet user, if authentication is enabled for the page, as part of the request,
current profile of the personal device (e.g. general, meeting, silent, etc.)
current theme set in the personal device (background image, color palette of the GUI, icons used)
sensory data, where the device is communicating with sensors. The sensory data may be GPS location, Barometric pressure, number of Bluetooth devices around, cellular signal strength, battery status, cellid, thermometer, moisture meter, accelerometer, specified mood for the device's owner.

It will be appreciated that the context data may be almost anything and therefore the previous listing should be considered only suggestive.

The basic steps for the invention are to request a content from a personal device and to determine which are the settings, i.e. context data, in the personal device. According to the settings, style for the layout of the content is retrieved from a configuration database. The style is used for rendering the page to be shown on a client device. When the browser receives the web page, it starts parsing it, and will realize that a certain style has to be applied, which style can be downloaded from a certain URL. Upon connecting to corresponding server, either mobile server or a stationary server, the given style may be retrieved from storage. The stationary server may be so called style web server, which provides styles for different users. The style that is retrieved does not necessarily exist on a server, when the page is requested. The style may be generated dynamically on the demand. If the style is generated on the fly, then it is basically a web application that does not serve ordinary pages formed by markup language, but documents of style data. One example of such a case is a style generator web application, when run on the personal device, may take the current theme on the device and generate corresponding style out of it. The new generated style may be stored for later use or removed permanently. After the browser has got the content and the configuration style, the browser renders the page and shows it to the user.

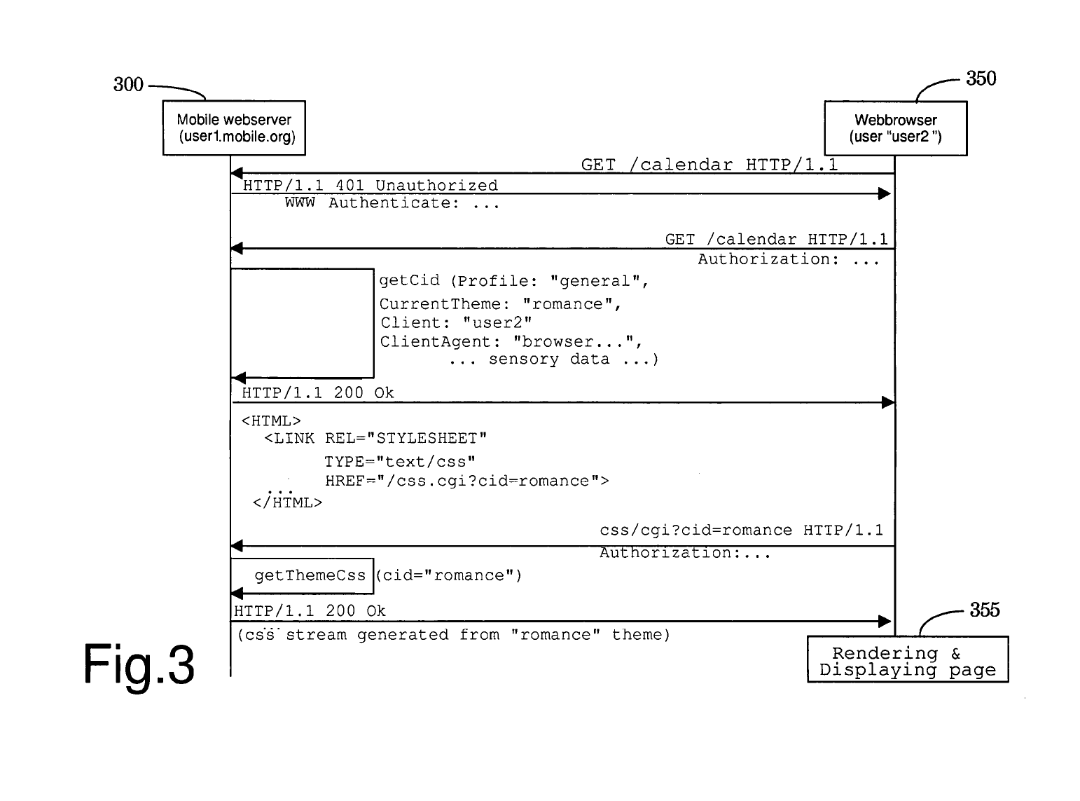

An example of a signalling for the invention and relating to FIG. 1 is illustrated in FIG. 3. In this example web browser user “user2” (350) and the mobile server owner “user1.mobile.org” (300) belongs to same family. User1 has configured the terminal 300 in such a way that family members may see the core applications (e.g. calendar) in said terminal 300. In this example the user2 requests an access to the calendar from the mobile server 300 (a). The mobile server 300 asks for authentication from the browser 350 (b), and after receiving it (c), the mobile server 300 determines the current settings and theme in the mobile terminal (d). The theme defines the style for the applications. In this example the theme is called “romance”. User 2's web browser 350 notices to use the style that is found at /css.cgi?cdi=romance address (i.e. an URL that refers to the same webserver that is the mobile server) (e). When the browser 350 asks for the corresponding style document (f), the style is either generated or served from the stored style database (g, h). After receiving both the style and the calendar, the browser is capable of rending and displaying the page 355.

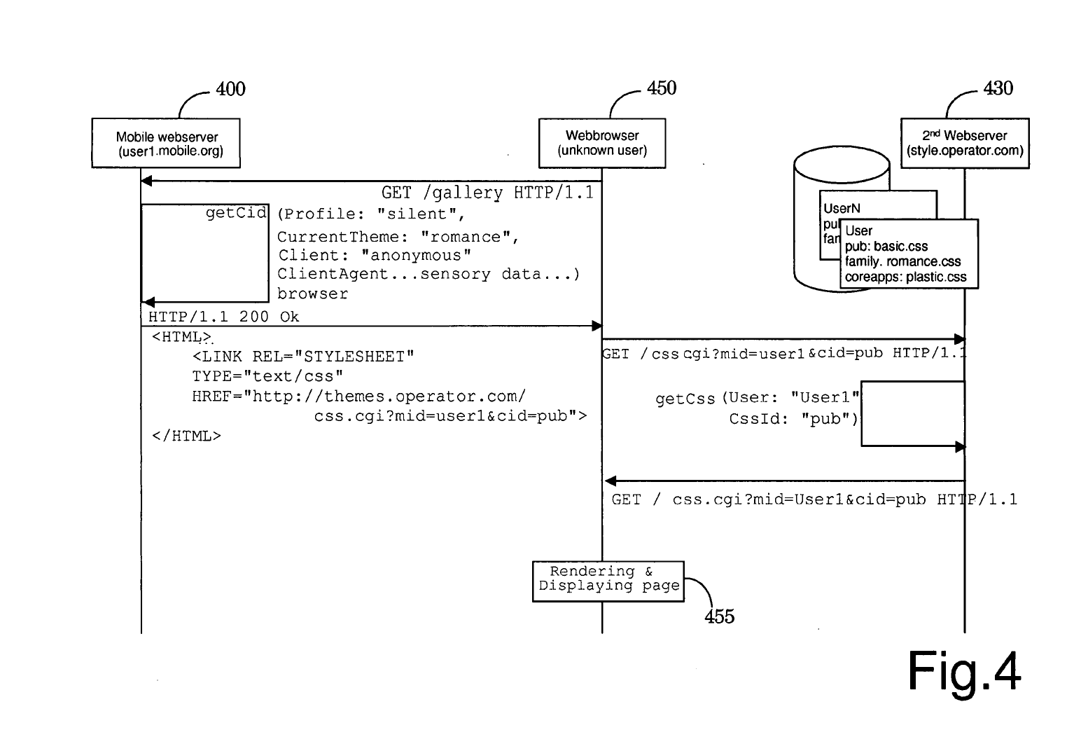

The FIG. 4 illustrates an example where web browser user 450 is anonymously accessing a publicly available page on the mobile terminal 400. The owner of the terminal 400 “user1” has configured style configuration on a second webserver 430. The second webserver 430 comprises a style generator being arranged to provide a style service that can be run by e.g. operators. The service enables people to configure parts of their styles on the second webserver 430, whereby the style can be retrieved only by calling the generator. In this example the user1 has configured that a public style “pub” should be theme “basic”. Therefore, when the web browser 450 requests gallery anonymously (a), the mobile server 400 determines the current settings (b), and returns (c) the link to the style server with a style identification “pub” and a style owner “user1”. The web browser 450 then requests (d) the corresponding style from the second server 430 being a style server, wherein it is examined (e) from whose data the style is to be searched and which style corresponds the identification “pub”. After determining that user1's style “pub” relates to basic style, the second server 430 returns (f) the style to the web browser 450, which is capable of rendering and displaying the page 455.

In one example a user may specify that all pages served from the personal device should be dressed with a basic look, except the core web applications (calendar, contacts, etc.) pages given out to family members. In the case of family members the pages should look personal. In another example, a user may configure the pages to behave more dynamically taking into account the GPS location and the barometric pressure to produce the web page look—e.g. tropical-sunny, Nordic-rainy—and even a calendar day, e.g. Christmas, Easter, or a season.

As further example, the context data may be a result of queries to third party servers. For example, if a personal device has GPS antenna but no barometric pressure, the device can connect to a weather forecast web service and query the current weather around the current GPS coordinates and map it to a style—if configured so by the user.

When serving a web page, the mobile server consults the configuration database to figure out which style to include with the page. The style commands are not necessarily inserted to the web page stream, but the style may be referred by its identifier, whereby the browser will make a subsequent request for the style in order to render the page.

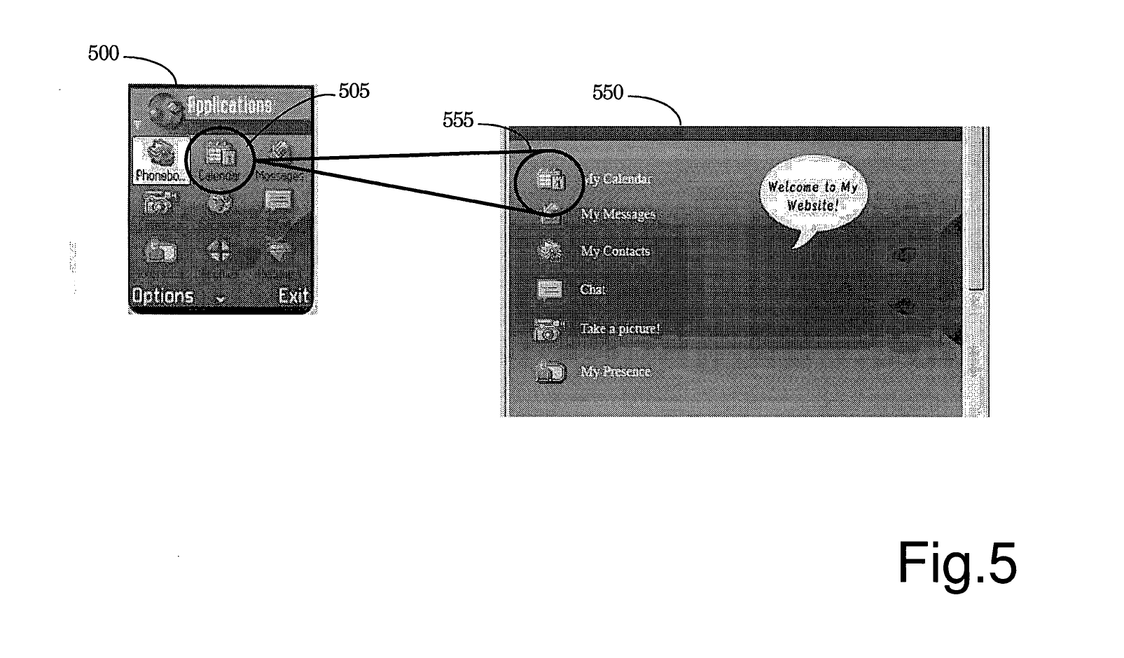

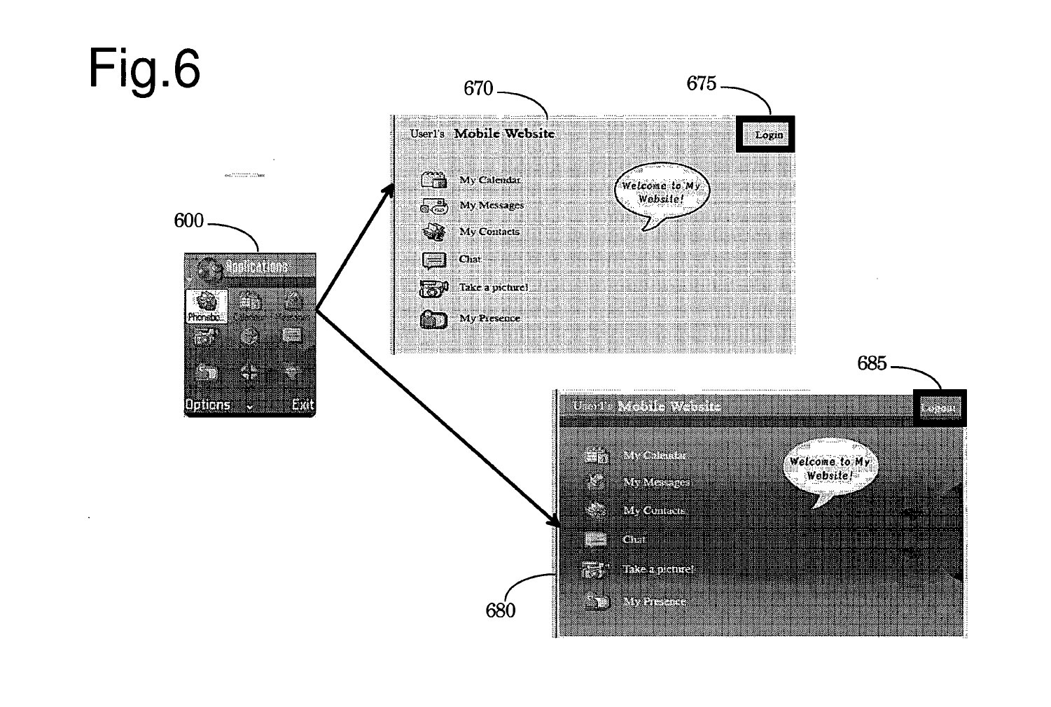

Few examples of screenshots from both personal device's display and the client device's display are illustrated in FIGS. 5-7. From FIG. 5 it can be seen that the content of the personal device's display 500 can be seen on the client device's display 550 with same style configuration and with same content. The icons (505, 555) and the colors used in the webpage 550 correspond the current theme of the personal device. In FIG. 6 the example is similar to the one in FIG. 5. However in this example different viewers get a different style. The content of the personal device 600 will be shown to the owner of the mobile server with the similar style that is used also in the device's user interface. It should be noted, that in the owner's case, the webpage resembles the device's user interface after the owner has logged in. Therefore the webpage in the client device 680 is also provided with “logout” button 685. Other users that are not logged in are given a different layout for the content in the personal device. Such browsers 670 may have default colors and icons, but also “login” button 675.

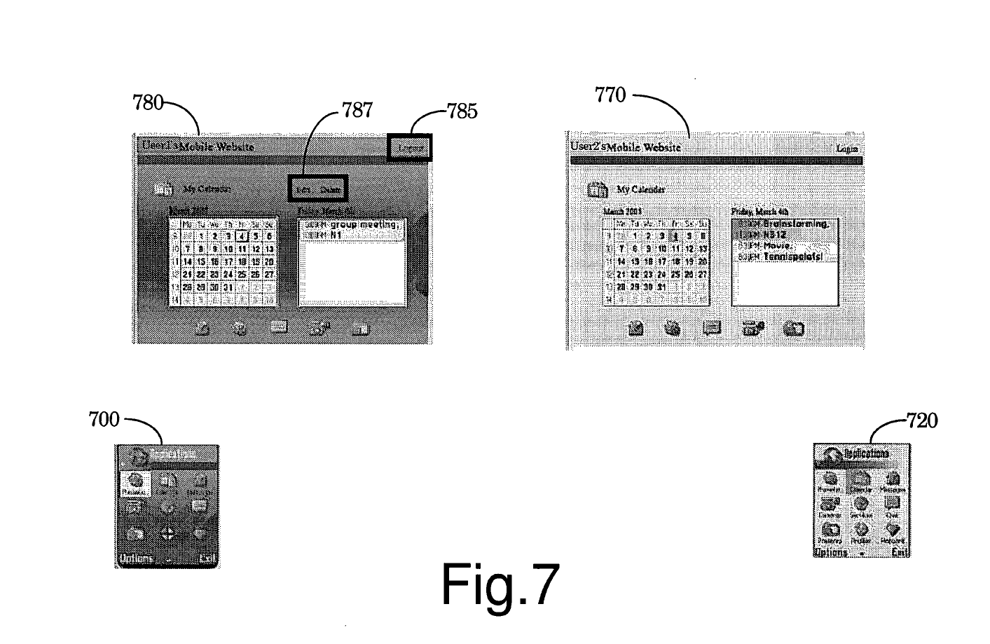

In FIG. 7 an example of comparing calendars is illustrated. In this example user1 desires to set up a meeting with user2. User1 will utilize his/her computer to locate the mobile website of user2 and accesses user2's calendar. The mobile website and the calendar of user1 are already open. User1 can easily differentiate which of the calendar views 780, 770 belongs to whom, because the calendars are named with the owner and the calendars may have different style with different colours and icons, because both of the calendars have the theme of the corresponding personal devices 700, 720. User1 has calendar functions (e.g. edit/delete 787) and logout button 785 for his/her own calendar in the webpage 780. However, access and edit option to user2's calendar is only provided if the user1 can login to user2's calendar.

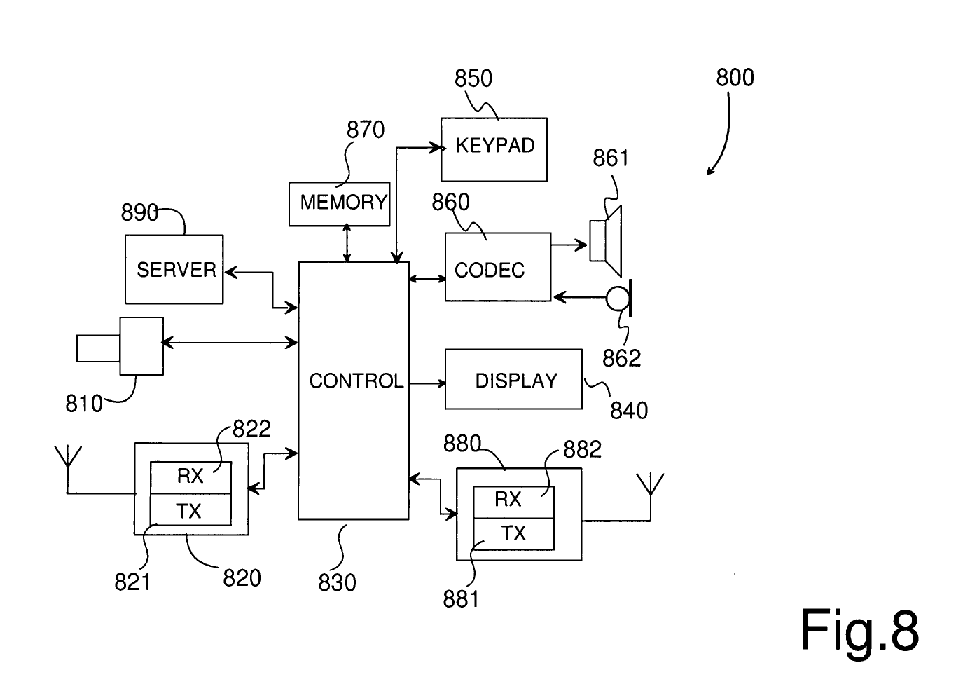

An example of a personal device is illustrated in FIG. 8. The device comprises communication means 820 having a transmitter 821 and a receiver 822 or is connected to such. There can also be other communicating means 880 having a transmitter 881 and a receiver 882 as well. The first communicating means 820 can be adapted for telecommunication and the other communicating means 880 can be a kind of short-range communicating means, such as a Bluetooth™ system, a WLAN system (Wireless Local Area Network) or other system which suits local use and for communicating with another device. The device 800 according to the example in FIG. 8 also comprises a display 840 for displaying visual information and the imaging data. Further the device 800 may comprise an interaction means, such as a keypad 850 for inputting data etc. In addition or instead of the keypad 850, the device can comprises stylus, whether the display is a touch-screen display. The device 800 comprises audio means 860, such as an earphone 861 and a microphone 862 and optionally a codec for coding (and decoding, if needed) the audio information. The device 800 can comprise also imaging means 810. A control unit 830 may be incorporated to the device 800 for controlling functions and running applications in the device 800. The control unit 830 may comprise one or more processors (CPU, DSP). Further the device comprises memory 870 for storing e.g. data, applications, and computer program code. The server 890 is to be used according to the aforementioned examples.

In the previous examples the URL where the style configuration is to be retrieved from may correspond to the personal device or to the style server. The style configuration may, but not necessarily does, exist when the browsable page referring to it is sent back to the browser. If the style is generated on the fly, then it is basically only a special web application that does not server ordinary e.g. HTML page but configuration styles. It can be seen, that this is analogous to the use of web applications that generate image based on submitted data (e.g. maps by means of street address). It will be appreciated that in addition to existing styles, the style generator being run in the personal device, may take the current theme on the device and generate corresponding style out of it.

When the style script runs locally on the personal device the amount of arguments to the script are less, e.g. http://user1.mobile.org/css.cgi?cid=curtheme. On the other hand, when the style script runs on another server, and various context data (in this example GPS location) is to be taken into account when generating the style, the amount of the arguments may be greater, e.g. http://style.operator.com/css.cgi?mid=user1&themeid=romance&gps=2 5E_{—}60N.

In the former examples CGI is being referred to as a way to generate CSS streams, but it will be appreciated by skilled person, that CGI is provided for understanding purposes only. The possible technology to use may vary, and e.g. Perl, Python and PHP can be used to program scripts generations. It is also possible to have “mycssgenerator” in C/C++ as well. In addition Java based technologies are possible alternatives as well. By understanding the great variety of the script languages, the person skilled in the art will also understand, that the invention is not limited to any of those, but can be implemented by some other technology.

It will be clear that variations and modifications of the examples of embodiment described are possible without departing from the scope of protection of the invention as set forth in the claims.

1. A method comprising:
retrieving content for a browsable document upon request,
determining context data relating to a personal device,
defining an information on a style relating to said context data, and
parsing the browsable document by utilizing the content and the information on the style.

2. The method according to claim 1, further comprising: retrieving the content for said document from a server of the personal device.

3. The method according to claim 1, wherein the information on the style is a style configuration of a identifier for the style configuration.

4. The method according to claim 1, further comprising: retrieving the style from a server of the personal device.

5. The method according to claim 1, further comprising: retrieving the style from a server external to the personal device.

6. The method according to claim 1, further comprising: retrieving the style is retrieved from a context configuration database.

7. The method according to claim 1, wherein the browsable document to be presented is a web page.

8. The method according to claim 1, wherein the content is one of the following group: home site, application data.

9. The method according to claim 1, wherein the context data being studied comprises at least one of the following group: a profile of the personal device, a location of the personal device, a time, a theme settings of the personal device, sensory data.

10. The method according to claim 1, further comprising:
forming the request of at least one of the following information: Uniform Resource Locator, an identifier of a browser, an identity of the browser's user.

11. The method according to claim 1, further comprising: generating the style on demand.

12. A configuration database arranged to:
determine context data relating to a device
define an information on a style relating to said context data.

13. A device for transferring browsable document to a client device, said device arranged to
retrieve a content to said browsable document upon request from the client device,
transfer said content to the client device,
determine context data relating to said device,
define an information on a style relating to said context data, and
transfer the browsable document with the content and the information on the style to the client device.

14. The device according to claim 13, further comprising a server.

15. The device according to claim 13, further comprising a configuration database for defining rules for the context data.

16. The device according to claim 15, further comprising a configuration database for defining information on the style.

17. The device according to claim 13, wherein the context data is one of the following group: a profile of the personal device, a location of the personal device, a time, a theme settings of the personal device, sensory data.

18. The device according to claim 13, further comprising a transmitter and a receiver for telecommunications.

19. A computer readable medium having computer software code stored thereon for creating a browsable document to be presented on a display, wherein said computer software code, when run on a computer, is configured to
determine context data relating to a personal device,
define an information on a style relating to said context data, and
parse the browsable document by utilizing the content and the information on the style.

20. A device for transferring browsable document to a client device, said device comprising:
means for retrieving a content to said browsable document upon request from the client device,
means for transferring said content to the client device,
means for determining context data relating to said device,
means for defining an information on a style relating to said context data, and
means for transferring the browsable document with the content and the information on the style to the client device.
